(19) United States
(12) Patent Application Publication
(10) Pub. No.: US 2015/0036175 A1
(43) Pub. Date: Feb. 5, 2015

(54) IMAGE FORMING DEVICE, COMPUTING DEVICE, AND METHOD AND APPARATUS FOR CONTROLLING DATA FLOW IN IMAGE FORMING DEVICE AND COMPUTING DEVICE OF IMAGE FORMING SYSTEM

(71) Applicant: Samsung Electronics Co., Ltd., Suwon-si (KR)

(72) Inventor: Tae-jung YUN, Seoul (KR)

(73) Assignee: Samsung Electronics Co., Ltd., Suwon-si (KR)

(21) Appl. No.: 14/219,499

(22) Filed: Mar. 19, 2014

(30) Foreign Application Priority Data
Aug. 1, 2013 (KR) 10-2013-0091590

(51) Int. Cl. G06F 3/12

(52) U.S. Cl. CPC G06F 3/1268; G06F 3/1293
USPC 358/1.15

(57) ABSTRACT

An image forming device and a computing device controlling data flow in an image forming system determine a device to perform an image job in the image forming system according to processing capabilities of devices existing in the image forming system, when the image job is requested, and perform the requested image job by using image data processed by the determined device.

### CROSS-REFERENCE TO RELATED APPLICATIONS

This application claims the priority benefit of Korean Patent Application No. 10-2013-0091590, filed on Aug. 1, 2013, in the Korean Intellectual Property Office, the disclosure of which is incorporated herein in its entirety by reference.

### BACKGROUND

1. Field

One or more embodiments relate to an image forming device and a computing device for controlling data flow in an image forming system, and a method of controlling data flow in the image forming device and the computing device.

2. Description of the Related Art

Image forming devices may include independent devices such as a printer, a scanner, a copying machine, and a facsimile, and multi-function peripheral (MFP) combining various functions of the above independent devices in a device. Recently, such image forming devices include a wired communication module such as Ethernet or a wireless communication module such as Wi-Fi, Wi-Fi Direct, near field communication (NFC), Bluetooth, ZigBee, and infrared data association (IrDA) so as to communicate with other devices such as mobile devices or laptop computers via a network. Also, the image forming devices may access a cloud server by using the above communication modules to upload/download documents to/from the cloud server.

### SUMMARY

In an aspect of one or more embodiments, there is provided an image forming device and a computing device for controlling data flow in an image forming system, and a method of controlling data flow in the image forming device or the computing device.

In an aspect of one or more embodiments, there is provided a computer readable recording medium having embodied thereon a program for executing the above method in a computer.

In an aspect of one or more embodiments, there is provided an image forming device controlling a data flow on an image forming system, the image forming device includes: an interface receiving a request for an image job; a control unit comparing processing capabilities of devices existing in the image forming system to determine at least one device that would perform an operation of generating image data related to the requested image job or an operation of transferring the image data; and an image forming unit performing the requested image job by using the image data processed by the determined at least one device.

Information about the processing capabilities may include information about the processing capabilities measured based on at least one of processing performances of processors included in the devices for performing the operation of generating the image data and communication performances of network interfaces included in the devices for performing the operation of transferring the image data between the devices.

The control unit may include: an estimation unit for estimating a time taken for finishing the operation of generating the image data in each of the devices based on the processing capabilities of the devices; and a device determination unit for determining a device having a shortest estimation time from among the devices.

The operation for generating the image data may be a rendering operation for converting original image data into the image data of a printable format.

The control unit may include: an estimation unit for estimating a time taken for finishing the operation of transferring the image data through each of data transmission paths that may be established between the devices, based on the processing capabilities of the devices; and a device determination unit for determining devices included in a data transmission path having a shortest estimation time from among the data transmission paths.

The data transmission paths may be established by using at least one of Wi-Fi, Wi-Fi Direct, near field communication (NFC), Bluetooth, Zigbee, infrared data association (IrDA), and a wired connection.

The interface may include: a user interface receiving information from a user and providing the user with information; and a network interface transmitting/receiving data by using at least one of wired connection and wireless connection, wherein the request for the image job may include at least one of a request input from the user via the user interface and a request transmitted from other devices out of the image forming device via the network interface.

The control unit may generate command information for controlling performing of the operation of generating the image data or the operation of transferring the image data in the determined at least one device, and if at least one device existing out of the image forming device is included in the determined at least one device, the network interface may transmit the command information to the at least one device existing out of the image forming device.

If at least one device existing out of the image forming device is included in the determined at least one device, the network interface may receive image data processed in the at least one device existing out of the image forming device, and the image forming unit may perform the requested image job by using the image data.

The network interface may receive information about the processing capabilities of the devices existing in the image forming system, and the control unit may determine the at least one device by using the information about the processing capabilities.

The devices existing in the image forming system may include the image forming device, at least one computing device, and at least one server device providing a cloud service.

In an aspect of one or more embodiments, there is provided a computing device for controlling data flow on an image forming system, the computing device includes: a network interface for transmitting a request for an image job to an image forming device existing in the image forming system; and a control unit for comparing processing capabilities of devices existing in the image forming system so as to determine at least one device that would process an operation of generating image data related to the requested image job or an operation of transferring the image data in the image forming system, wherein the control unit may control performing of the operation of generating the image data or the operation of transferring the image data in the determined at least one device.

The information about the processing capabilities may include information about the processing capabilities measured based on at least one of processing performances of processors included in the devices for performing the operation of generating the image data and communication performances of network interfaces included in the devices for performing the operation of transferring the image data between the devices.

In an aspect of one or more embodiments, there is provided a method of controlling data flow in an image forming device of an image forming system, the method includes: receiving a request for an image job; receiving information about processing capabilities of devices existing in the image forming system; comparing processing capabilities of devices existing in the image forming system so as to determine at least one device that would process an operation of generating image data related to the requested image job or an operation of transferring the image data in the image forming system; and performing the requested image job by using image data processed by the determined at least one device.

The information about the processing capabilities may include information about at least one of processing performances of processors included in the devices for performing the operation of generating the image data and communication performances of network interfaces included in the devices for performing the operation of transferring the image data between the devices.

The determining of the at least one device may include: estimating at least one of a time taken for finishing the operation of generating the image data in each of the devices and a time taken for finishing the operation of transferring the image data through each of data transmission paths that may be established between the devices, based on the processing capabilities of the devices; and determining at least one of a device having a shortest estimation time and devices included in a data transmission path having a shortest estimation time from among the data transmission paths.

The method may further include: generating command information for controlling performing of the operation of generating the image data or the operation of transferring the image data in the at least one determined device; and if at least one device existing out of the image forming device is included in the at least one determined device, transferring the command information to the at least one device existing out of the image forming device.

The method may further include, if at least one device existing out of the image forming device is included in the at least one determined device, receiving image data processed in the at least one device existing out of the image forming device, wherein the performing of the image job may include performing the requested image job by using the image data.

In an aspect of one or more embodiments, there is provided a method of controlling data flow in a computing device of an image forming system, the method includes: transmitting a request for an image job to an image forming device existing in the image forming system; receiving information about processing capabilities of devices existing in the image forming system; comparing processing capabilities of devices existing in the image forming system so as to determine at least one device that would process an operation of generating image data related to the requested image job or an operation of transferring the image data in the image forming system; and controlling performing of the requested image job in the at least one determined device.

According to one or more embodiments, a computer readable recording medium includes a program for executing the method of controlling data flow in an image forming device of an image forming system.

According to an aspect of one or more embodiments, there is provided at least one computer readable medium storing computer readable instructions to implement methods of embodiments.

### BRIEF DESCRIPTION OF THE DRAWINGS

These and/or other aspects will become apparent and more readily appreciated from the following description of embodiments, taken in conjunction with the accompanying drawings of which:

FIG. 1 is a diagram of an image forming system according to an embodiment;

FIG. 2 is a block diagram of hardware configuration in an image forming device according to an embodiment;

FIG. 3 is a diagram illustrating data transmission paths that may be established in the image forming system according to an embodiment;

FIG. 4 is a diagram showing examples of time estimation of transmission operations through the data transmission paths that may be established in the image forming system according to an embodiment;

FIG. 5 is a diagram showing subjects capable of performing a rendering operation of image data in the image forming system according to an embodiment;

FIG. 6 is a diagram showing examples of time estimation of rendering operations performed in each of devices in the image forming system according to an embodiment;

FIG. 7 is a diagram illustrating determination of a data flow on an image forming system in consideration of times for performing data transmissions and rendering operations in devices according to an embodiment;

FIG. 8 is a block diagram showing hardware configuration of the computing device according to an embodiment;

FIG. 9 is a diagram showing processes of controlling data flow in the image forming device, the computing device, and the server device according to an embodiment;

FIG. 10 is a diagram showing processes of controlling data flow in an image forming device, a computing device, and a server device according to an embodiment;

FIG. 11 is a diagram illustrating processes of controlling data flow in the image forming device of the image forming system according to an embodiment; and

FIG. 12 is a diagram illustrating processes of controlling data flow in the computing device of the image forming system.

### DETAILED DESCRIPTION

Reference will now be made in detail to embodiments, examples of which are illustrated in the accompanying drawings, wherein like reference numerals refer to the like elements throughout. In this regard, the present embodiments may have different forms and should not be construed as being limited to the descriptions set forth herein. Accordingly, embodiments are merely described below, by referring to the figures, to explain aspects of the present description. Expressions such as “at least one of,” when preceding a list of elements, modify the entire list of elements and do not modify the individual elements of the list.

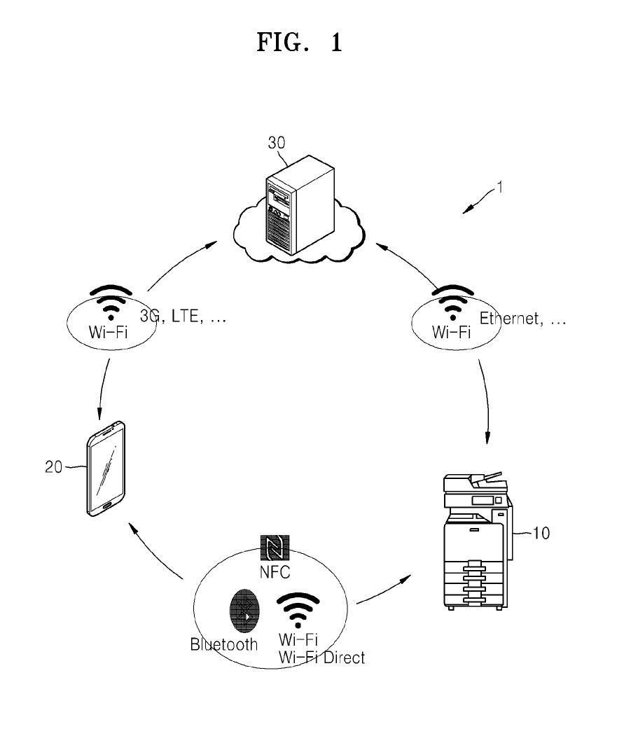

FIG. 1 is a diagram showing an image forming system 1 according to an embodiment. Referring to FIG. 1, the image forming system 1 includes an image forming device 10, a computing device 20, and a server device 30.

In the image forming system 1 of FIG. 1, it is assumed that one image forming device 10, one computing device, and one server device 30 are formed; however, embodiments are not limited thereto, that is, one or more kinds of image forming devices 10, computing devices 20, and server devices 30 may exist in the image forming system 1.

That is, FIG. 1 only shows hardware components relating to the present embodiment for convenience of description. However, one of ordinary skill in the art would appreciate that other universal hardware components, for example, an access point (AP), a network hub, and the like may be included in the image forming system 1.

The image forming device 10 may be a device such as a printer, a scanner, a copying machine, or a facsimile, or a multi-function peripheral (MFP) combining various functions of such above devices as one device.

The computing device 20 may be a smartphone, a tablet device, a personal digital assistant (PDA), a laptop computer, or a personal computer (PC).

The server device 30 may be a cloud server providing a cloud service, a web server providing a web hosting function, or a database (DB) server.

The image forming device 10, the computing device 20, and the server device 30 existing in the image forming system 1 are capable of communicating with each other through wired or wireless communication.

The image forming device 10 may include a wired network interface such as Ethernet interface, or a wireless network interface such as Wi-Fi, Wi-Fi Direct, near field communication (NFC), Bluetooth, Zigbee, or infrared data association (IrDA).

As described above, the computing device 20 may be a portable device such as a smartphone, a tablet device, a PDA, or a laptop computer. If the computing device 20 is a portable device, the computing device 20 may support a wireless communication function such as the Wi-Fi, Wi-Fi Direct, NFC, or Bluetooth. In particular, if the computing device 20 is a mobile device such as a smartphone or a tablet device, the computing device 20 may support a mobile communication network function such as a third generation (3G) or long term evolution (LTE) communication.

If the server device 30 is a cloud server or a web server, a plurality of external devices having Ethernet interface function, a mobile communication network function, and a Wi-Fi function may be connected to the server device 30.

As described above, the image forming device 10, the computing device 20, and the server device 30 in the image forming system 1 may form a wired or wireless network by using the wired or wireless communication function provided therein.

That is, the wired or wireless communication types used in the image forming device 10, the computing device 20, and the server device 30 are examples, that is, any kind of wired or wireless communication type may be applied to embodiments, provided that the image forming system 1 connected via a wired or wireless network may be established.

The image forming system 1 is a system for executing an image job requested by the computing device 20 or the server device 30 by using the image forming device 10. Otherwise, a user may directly request the image forming device 10 to execute an image job on the image forming system 1.

In general, an image job (for example, a printing operation) is performed when an MFP receiving a request for the printing operation from a certain host device (for example, a PC) prints image data according to the requested operation. That is, the MFP receives image data about the image job transmitted from a host device, and then, may only perform the image job by using the transmitted image data.

Therefore, if there are many spooling operations are in standby in the MFP, it may be difficult to finish an image job requested by a host device until the standby spooling operations are finished. For example, since the MFP may not start a rendering operation of original image data transferred from a host device until the spooling operations that are in standby mode are finished, the host device has to wait until the spooling operations are finished and the rendering operation of the transferred original image data is finished.

Also, an available network bandwidth of the MFP is limited, and thus, when the MFP is receiving image data of large capacity from another host device, the host device may not rapidly transfer the original image data to the MFP.

That is, since a fixed data transmission path and limited processing resource or network resource of the MFP are used according to the prior art, image jobs between the devices may not be performed effectively or rapidly.

However, according to the image forming device 10 or the computing device 20 according to the present embodiment, data flow in the image forming system 1 may be dynamically controlled according to a current circumstance, and thus, image jobs may be performed more effectively and rapidly than the prior art, in which the fixed path and the limited resources are used.

In more detail, the image forming system 1 may dynamically control the data flow by using a conception similar to a quality of service (QoS). That is, the image forming device 10, the computing device 20, and the server device 30 may control the data flow in the image forming system 1 so that data relating to the image job may be transmitted through an optimal data transmission path and the image data may be processed in a device having available processing resource that is optimized. Here, the QoS is adopted to transmit the data reliably on Internet or a network or to control network traffics optimally.

Hereinafter, detailed operations and functions of the devices 10, 20, and 30 in the image forming system 1 for controlling the data flow will be described below.

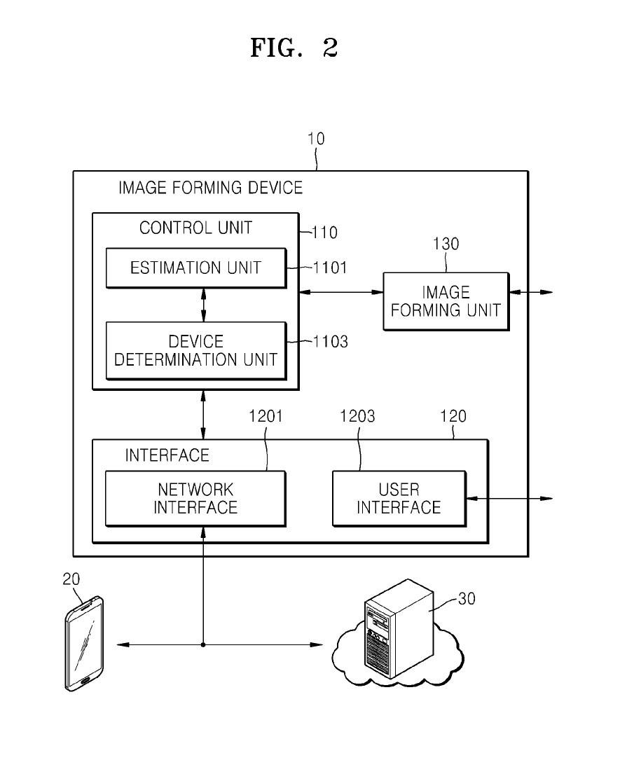

FIG. 2 is a block diagram showing hardware configuration of the image forming device 10.

FIG. 2 only shows hardware components relating to the present embodiment for convenience of description. However, one of ordinary skill in the art would appreciate that other universal hardware components may be included in the image forming system 1, besides the hardware component shown in FIG. 2.

Referring to FIG. 2, the image forming device 10 includes a control unit (controller) 110, an interface 120, and an image forming unit 130. Also, the control unit 110 includes an estimation unit (estimator) 1101 and a device determination unit (device determiner) 1103, and the interface 120 includes a network interface 1201 and a user interface 1203. The control unit 110 in the image forming device 10 may be a processor such as a central processing unit (CPU). Such a processor may be configured as an array of a plurality of logic gates, or a universal micro processor. That is, the control unit 110 may be realized as a hardware module or a software module of various types.

The network interface 1201 is hardware for connecting the image forming device 10 to a network, and may include a wired communication module (Ethernet interface), or a wireless communication module (a wireless local area network (LAN) supporting Wi-Fi or Wi-Fi Direct, an NFC module, or a Bluetooth module).

The network interface 1201 receives a request for an image job from an external device via the wired communication module or the wireless communication module. Here, the external device may correspond to the computing device 20 or the server device 30.

That is, the network interface 1201 may receive a request for a mobile printing operation from the computing device 20 (a smartphone or a tablet device), or a request for a cloud printing operation (for example, a Google Could Printing operation) from the server device 30.

Instead of receiving a request for an image job from the computing device 20 or the server device 30 via the network interface 1201, the user interface 1203 may directly receive a request for an image job from the user.

When a request for an image job is transferred from one of the devices 20 and 30 or the user, the network interface 1201 may receive information about processing capabilities (processing capability information) from the devices (the computing device 20 and the server device 30) on the image forming system 1 configuring the current network. However, information about current available processing capacity of the image forming device 10 itself may not need to be separately transferred via the network interface 1201.

Here, the information about the processing capabilities may include information measured based on the processing performance of the processor for generating image data included in each of the devices (image forming device 10, the computing device 20, and the server device 30) of the image forming system 1. Also, the information about the processing capabilities may include information measured based on a communication performance of the network interface for transferring data between the devices (the image forming device 10, the computing device 20, and the server device 30) of the image forming system 1.

The control unit 110 compares the processing capabilities of the image forming device 10, the computing device 20, and the server device 30 to determine at least one device that will process an operation of generating or transferring the image data about the image job requested in the image forming system 1. That is, the control unit 110 determines the image forming device 10, the computing device 20, or the server device 30 as a subject of processing the generating operation or the transferring operation.

In more detail, the estimation unit 1101 of the control unit 110 estimates a time that will be taken to finish the data transmission operation through each of different data transmission paths that may be established between the devices 10, 20, and 30, based on the processing capability of each of the devices 10, 20, and 30. Here, the data transmission paths may be, for example, various paths that are established between the devices 10, 20, and 30 by using the Wi-Fi, the Wi-Fi Direct, NFC, Bluetooth, Zigbee, IrDA, or wired connection.

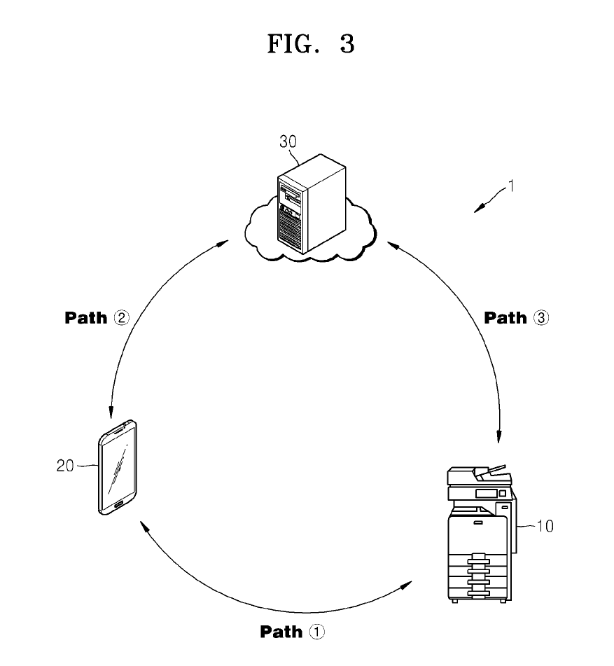

FIG. 3 is a diagram illustrating data transmission paths that may be established on the image forming system 1 according to an embodiment.

Referring to FIG. 3, a case where the computing device 20 requests the image forming device 10 to execute an image job will be described as an example.

One of the data transmission paths that may be established on the image forming system 1 is a path \textcircled{1} between the image forming device 10 and the computing device 20. Also, another data transmission path may be a path \textcircled{2}+\textcircled{3} including a path \textcircled{2} between the computing device 20 and the server device 30 and a path \textcircled{3} between the image forming device 10 and the server device 30.

Referring back to FIG. 2, the device determination unit 1103 of the control unit 110 determines devices included in the data transmission path having the shortest estimation time between the data transmission paths (the path \textcircled{1} and the path \textcircled{2}+\textcircled{3}).

For example, if the estimation time of the path \textcircled{1} is the shortest, the device determination unit 1103 determines the image forming device 10 and the computing device 20 included in the path \textcircled{1}. However, if the estimation time of the path \textcircled{2}+\textcircled{3} is the shortest, the device determination unit 1103 determines the image forming device 10, the computing device 20, and the server device 30 included in the path \textcircled{2}+\textcircled{3}.

That is, the data transmission path through the at least one device determined by the device determination unit 1103 has the processing capability that may process the transferring operation of the image data at the fastest speed.

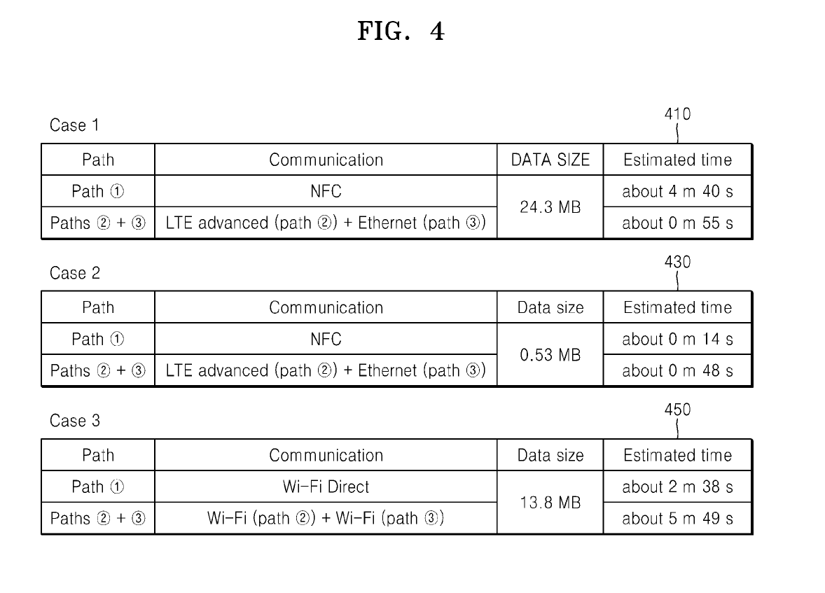

FIG. 4 shows examples of the estimation times for transferring the data through the data transmission paths that may be established on the image forming system 1 according to an embodiment.

Referring to case 1 (410) shown in FIG. 4, the path \textcircled{1} is formed by connecting the image forming device 10 and the computing device 20 via the NFC. In addition, the path \textcircled{2}+\textcircled{3} is formed by connecting the computing device 20 and the server device 30 via LTE advanced (path \textcircled{2}) and connecting the image forming device 10 and the server device 30 via Ethernet (path \textcircled{3}).

If a size of the image data about the image job is 24.3 MB, the estimation unit 1101 estimates a time taken to finish the transmission operation through the path \textcircled{1} as 4 min. and 40 sec. based on the processing capabilities of the image forming device 10 and the computing device 20, as described above. In addition, the estimation unit 1101 estimates a time taken to finish the transmission operation through the path \textcircled{2}+\textcircled{3} as 55 sec. based on the processing capabilities of the image forming device 10, the computing device 20, and the server device 30.

According to the case 1 (410), the device determination unit 1103 determines the image forming device 10, the computing device 20, and the server device 30 included in the path \textcircled{2}+\textcircled{3} having the shortest estimation time between the data transmission paths (path \textcircled{1} and path \textcircled{2}+\textcircled{3}).

Referring to case 2 (430), the path \textcircled{1} is formed by connecting the image forming device 10 and the computing device 20 via the NFC. In addition, the path \textcircled{2}+\textcircled{3} is formed by connecting the computing device 20 and the server device 30 via LTE advanced (path \textcircled{2}) and connecting the image forming device 10 and the server device 30 via Ethernet (path \textcircled{3}).

If a size of the image data about the image job is 0.53 MB, the estimation unit 1101 estimates a time taken to finish the transmission operation through the path \textcircled{1} as 14 sec. based on the processing capabilities of the image forming device 10 and the computing device 20, as described above. In addition, the estimation unit 1101 estimates a time taken to finish the transmission operation through the path \textcircled{2}+\textcircled{3} as 48 sec.

That is, according to the case 2 (430), the device determination unit 1103 determines the image forming device 10 and the computing device 20 included in the path \textcircled{1} having the shortest estimation time, unlike in the case 1 (410).

Referring to case 3 (450), the path \textcircled{1} is formed by connecting the image forming device 10 and the computing device 20 via the Wi-Fi Direct. In addition, the path \textcircled{2}+\textcircled{3} is formed by connecting the computing device 20 and the server device 30 via Wi-Fi (path \textcircled{2}) and connecting the image forming device 10 and the server device 30 via Wi-Fi (path \textcircled{3}).

If a size of the image data about the image job is 13.8 MB, the estimation unit 1101 estimates a time taken to finish the transmission operation through the path \textcircled{1} as 2 min. and 38 sec. based on the processing capabilities of the image forming device 10 and the computing device 20. In addition, the estimation unit 1101 estimates a time taken to finish the transmission operation through the path \textcircled{2}+\textcircled{3} as 5 min. and 49 sec.

According to the case 3 (450), the device determination unit 1103 determines the image forming device 10 and the computing device 20 included in the path \textcircled{1} having the shortest estimation time.

Referring back to FIG. 2, the estimation unit 1101 of the control unit 110 may determine at least one device in another way.

In particular, the estimation unit 1101 of the control unit 110 estimates a time taken to finish the operation of generating image data in each of the devices 10, 20, and 30 based on the processing capabilities of the devices 10, 20, and 30. Here, the operation of generating image data may include, for example, a rendering operation for converting original image data into image data of a printable format.

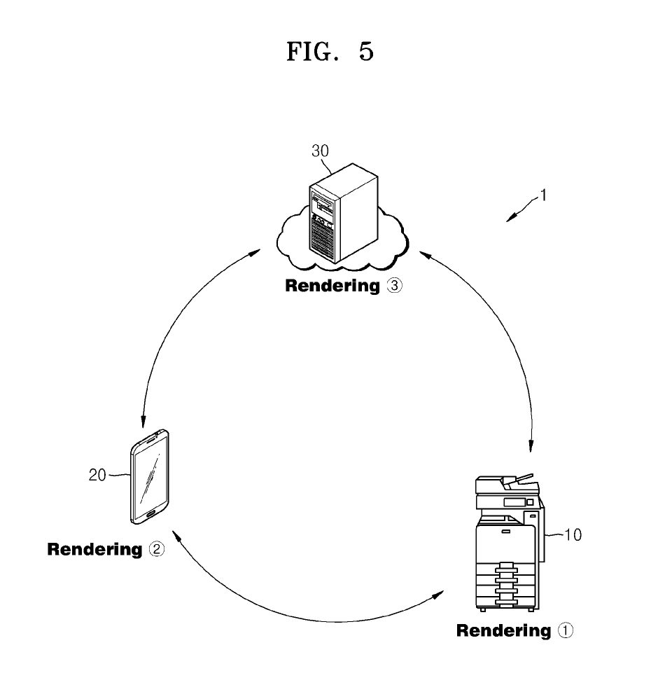

FIG. 5 is a diagram illustrating subjects capable of executing the rendering operation of image data in the image forming system 1 according to an embodiment.

Referring to FIG. 5, each of the devices 10, 20, and 30 in the image forming system 1 includes a processor that may perform a rendering operation of the image data.

Hereinafter, a rendering \textcircled{1} denotes a case where the image forming device 10 performs the rendering operation. Rendering \textcircled{2} denotes a case where the computing device 20 performs the rendering operation, and rendering \textcircled{3} denotes a case where the server device 30 performs the rendering operation (cloud rendering).

In a case of a mobile printing operation, it may be set in advance that the rendering operation of the image data is to be performed in the image forming device 10 (rendering \textcircled{1}).

Referring back to FIG. 2, the device determination unit 1103 determines a device having the shortest estimation time from among the devices 10, 20, and 30. The device determined by the device determination unit 1103 may be a device having the processing capability of performing the method of generating the image data at the fastest speed.

Therefore, according to the image forming system 1 of the present embodiment, if there are many spooling operations or rendering operations in standby modes in the image forming device 10, the computing device 20 or the server device 30 may perform the operation of generating the image data, instead of the image forming device 10.

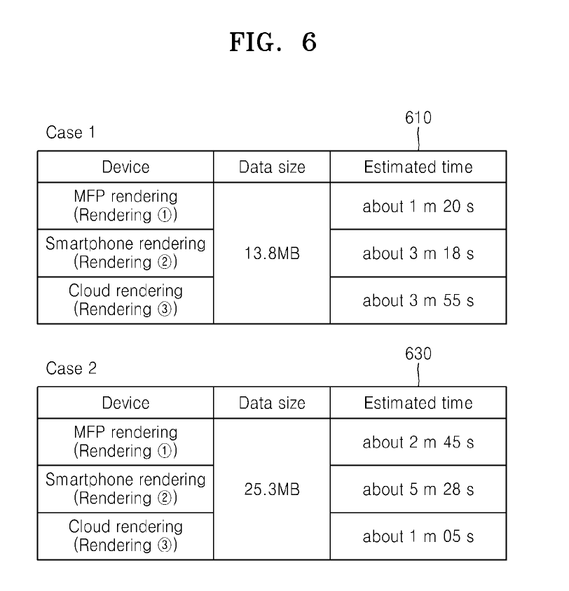

FIG. 6 is a diagram showing examples of estimation times in cases where the rendering operation is performed in the devices 10, 20, and 30 of the image forming system 1 according to an embodiment.

Referring to case 1 (610) shown in FIG. 6, when a size of the original image data is 13.8 MB, the estimation time for performing the rendering \textcircled{1} (MFP rendering) is 1 min. and 20 sec. In addition, the estimation time for performing the rendering \textcircled{2} (smartphone rendering) is 3 min. and 18 sec., and the estimation time for performing the rendering \textcircled{3} (cloud rendering) is 3 min. and 55 sec.

Therefore, the device determination unit 1103 determines the rendering \textcircled{1} (MFP rendering) having the shortest time for performing the rendering operation from among the devices 10, 20, and 30.

Referring to case 2 (630), when a size of the original image data is 25.3 MB, the estimation time for performing the rendering \textcircled{1} (MFP rendering) is 2 min. and 45 sec. In addition, the estimation time for performing the rendering \textcircled{2} (smartphone rendering) is 5 min. and 28 sec. Moreover, the estimation time for performing the rendering \textcircled{3} (cloud rendering) is 1 min. and 5 sec.

Therefore, the device determination unit 1103 determines the rendering \textcircled{3} (cloud rendering) having the shortest estimation time for performing the rendering operation.

According to the present embodiment, even if the mobile printing is set as the rendering \textcircled{1} in advance, the rendering operation may not be necessarily performed in one set device (image forming device 10). That is, a subject of the rendering operation may be dynamically changed to a device that may optimize the rendering operation in the image forming system 1.

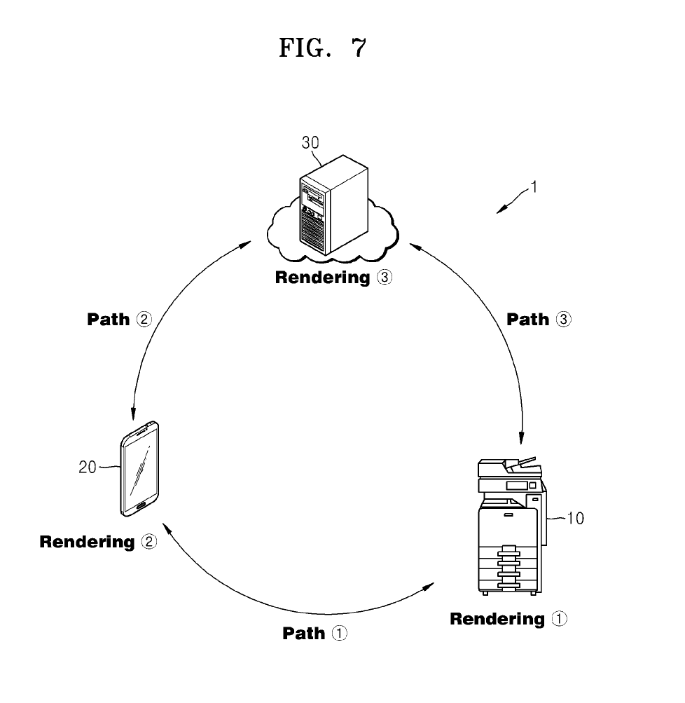

FIG. 7 is a diagram illustrating determination of the data flow on the image forming system 1 in consideration of the times for performing the data transmissions and the rendering operations in the devices 10, 20, and 30 according to an embodiment.

Referring to FIG. 7, an example in which the computing device 20 requests the image forming device 10 to perform an image job; however, embodiments are not limited thereto.

The control unit 110 may determine at least one device in consideration of the data transmission times and the rendering times described with reference to FIGS. 4 through 6.

The image data is processed in a device having the shortest rendering time and may be transmitted to the image forming device 10 through a data transmission path having the shortest transmission time in the image forming system 1.

However, for example, even when the rendering time of the rendering \textcircled{3} is the shortest, it may take a lot of time to perform the transmission operation through the path \textcircled{2}+\textcircled{3}. That is, even if the rendering time of the rendering \textcircled{2} is longer than that of the rendering \textcircled{3}, a total time including the rendering time of the rendering \textcircled{2} and the data transmission time to the image forming device 10 through the path \textcircled{1} may be less than any other cases.

In addition, the control unit 110 may determine at least one device that may optimize the data flow in the image forming system 1 by combining the above description with reference to FIGS. 4 through 6. For example, the control unit 110 may determine one device so that the total time including the data transmission time and the rendering time becomes the least. Otherwise, the control unit 110 may determine at least one device so that a total time including the data transmission time and the rendering time to which different weights are applied may become the least.

Referring back to FIG. 2, when the device determination unit 1103 of the control unit 110 determines at least one device, the control unit 110 generates command information for controlling execution of the generation operation or the transmission operation in the determined at least one device.

For example, in case 1 (410) of FIG. 4, the control unit 110 may generate command information for controlling transmission of the image data in the computing device 20 and the server device 30 so that the data transmission operation may be performed via the computing device 20 and the server device 30. Otherwise, in case 2 (430) of FIG. 4, the control unit 110 may generate command information for controlling the transmission of the image data from the computing device 20 so that the transmission operation may be performed from the computing device 20. Otherwise, according to case 1 (610) of FIG. 6, the control unit 110 may generate command information for starting the rendering in the image forming device 10 so that the data generation operation (rendering operation) may be performed in the image forming device 10. Otherwise, according to case 2 (630) of FIG. 6, the control unit 110 may generate command information for controlling the rendering of the server device 30 so that the rendering operation (cloud rendering) may be performed in the server device 30.

The network interface 1201 transmits the command information generated by the control unit 110 to the determined at least one device. Here, the transmission of the command information performed by the network interface 1201 may correspond to a case where the computing device 20 or the server device 30 is included in the at least one device determined by the control unit 110.

That is, if the image forming device 10 is only included in the device determined by the control unit 110, the network interface 1201 does not need to transmit the command information. That is, in a case where the image forming device 10 is only included in the device determined by the control unit 110, the control unit 110 may process the command information in the image forming device 10.

If the computing device 20 or the server device 30 is included in the determined at least one device, the network interface 1201 receives the processed image data from the computing device 20 and the server device 30. If the image forming device 10 is only included in the device determined by the control unit 110, the image forming device 10 may process the image data internally.

The image forming unit 130 performs the requested image job by using the image data transmitted from the computing device 20 or the server device 30, or the image data processed in the image forming device 10.

The image forming unit 130 according to the present embodiment may include print hardware performing printing and copying operations, scanner hardware performing a scanning operation, or facsimile hardware performing a fax operation. That is, the image forming unit 130 denotes the hardware performing the image operations generally performed in the image forming device 10.

The image operation performed by the image forming unit 130 may include an operation of transmitting a scanned document to an external device of the image forming device 10 (the computing device 20 or the server device 30) after the scanning operation (for example, Scan to email or Scan to server). Here, the image forming device 10 may transmit the scanned document to outside via the at least one device determined by the control unit 110.

That is, the present embodiment may be applied to the image data generation operation or the image data transmission operation that may be performed in the image forming system 1.

So far, an example in which the image forming device 10 controls the data flow on the image forming system 1. However, embodiments are not limited thereto, that is, the computing device 20 may be the subject to determine the control of the data flow on the image forming system 1.

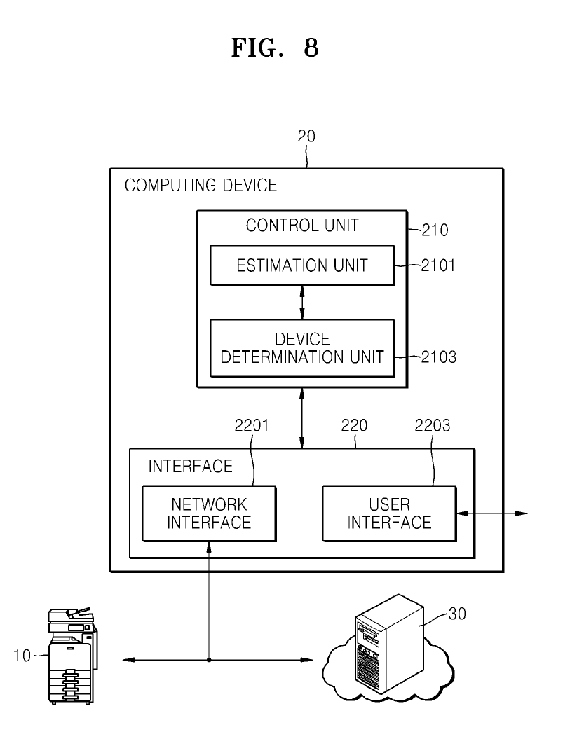

FIG. 8 is a block diagram showing hardware configuration of the computing device 20 according to an embodiment.

FIG. 8 shows hardware components that are related to an embodiment for convenience of description. However, other universal hardware components in addition to the hardware components shown in FIG. 8 may be included in the computing device 20.

Referring to FIG. 8, the computing device 20 includes a control unit (controller) 210 and an interface 220. In addition, the control unit 210 includes an estimation unit (estimator) 2101 and a device determination unit (device determiner) 2103, and the interface 120 includes a network interface 2201 and a user interface 2203. The control unit 210 of the computing device 20 may be a processor such as a CPU. Such a processor may be configured as an array of a plurality of logic gates, or a universal micro processor. That is, the control unit 210 may be realized as a hardware module or a software module of various types.

The network interface 2201 is hardware for connecting the computing device 20 to a network, and may include a wired communication module (Ethernet interface), or a wireless communication module (a wireless local area network (LAN) supporting Wi-Fi or Wi-Fi Direct, an NFC module, or a Bluetooth module). If the computing device 20 is a mobile device such as a smartphone, a tablet device, or a laptop computer, or a portable device, the computing device 20 may not include the wired communication module (Ethernet interface). However, if the computing device 20 is a PC, the computing device 20 may include both the wired and wireless communication modules.

The network interface 2201 transmits a request for an image job (for example, a mobile printing operation) to the image forming device 10.

The network interface 2201 receives information about currently available processing capabilities from the devices (image forming device 10 and the server device 30) in the image forming system 1 before or after transmitting the request for the image job to the image forming device 10. However, the currently available processing capability of the computing device 20 may not need to be received through the network interface 2201.

Here, the information about the processing capabilities may include information measured based on the processing performance of the processor for generating image data included in each of the devices (image forming device 10, the computing device 20, and the server device 30) of the image forming system 1. Also, the information about the processing capabilities may include information measured based on a communication performance of the network interface for transferring data between the devices (the image forming device 10, the computing device 20, and the server device 30) of the image forming system 1.

The control unit 210 compares the processing capabilities of the image forming device 10, the computing device 20, and the server device 30 to determine at least one device that will process an operation of generating or transferring the image data about the image job requested in the image forming system 1. That is, the control unit 210 determines the image forming device 10, the computing device 20, or the server device 30 as a subject of processing the generating operation or the transferring operation.

In more detail, the estimation unit 2101 of the control unit 210 estimates a time that will be taken to finish the data transmission operation through each of different data transmission paths that may be established between the devices 10, 20, and 30, based on the processing capability of each of the devices 10, 20, and 30. Here, the data transmission paths may be, for example, various paths that are established between the devices 10, 20, and 30 by using the Wi-Fi, the Wi-Fi Direct, NFC, Bluetooth, Zigbee, IrDA, or wired connection.

The device determination unit 2103 of the control unit 210 determines devices included in the data transmission path having the shortest estimation time from among the data transmission paths that may be established.

Moreover, the estimation unit 2101 of the control unit 210 may determine at least one device based on another way.

The estimation unit 2101 of the control unit 210 estimates times to finish the operations for generating the image data in the devices 10, 20, and 30 based on the processing capabilities of the devices 10, 20, and 30. Here, the image data generation operation may include a rendering operation for converting original image data into image data of a printable format.

The device determination unit 2103 of the control unit 210 determines a device having the shortest estimation time from among the devices 10, 20, and 30.

That is, the control unit 210 of the computing device 20 may determine the at least one device similarly to the control unit 110 of the image forming device 10. Therefore, the operations of the control unit 110 in the image forming device 10 described with reference to FIGS. 4 through 7 may be applied to the operations of the control unit 210 of the computing device 20.

When the device determination unit 2103 determines the at least one device, the control unit 210 controls the determined at least one device to perform the generation operation or the transfer operation. That is, the control unit 210 may generate command information to control the determined at least one device, similarly to the control unit 110 of the image forming device 10.

The image forming device 10 receives image data that is processed according to the command information generated by the control unit 210 of the computing device 20, and performs the image job requested by the computing device 20.

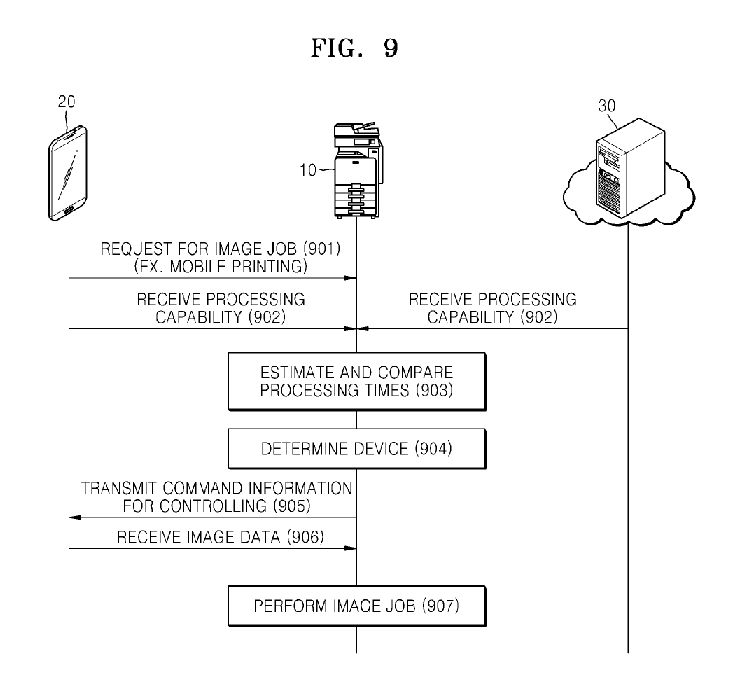

FIG. 9 is a diagram showing processes of controlling data flow in the image forming device 10, the computing device 20, and the server device 30 according to an embodiment. Referring to FIG. 9, the processes of controlling the data flow are time-serially performed processes in the devices 10, 20, and 30 described with reference to FIGS. 1 through 7, and thus, the descriptions with reference to FIGS. 1 through 7 may be applied to the processes of controlling the data flow in FIG. 9.

The controlling of the data flow shown in FIG. 9 is performed by the image forming device 10. In addition, the processes of controlling the data flow shown in FIG. 9 will be described under an assumption of the path \textcircled{1} shown in FIG. 4 and the rendering \textcircled{2} shown in FIG. 6. However, an embodiment is not limited thereto.

In operation S901, the network interface 1201 receives a request for an image job (for example, a mobile printing operation) from the computing device 20 (for example, a smartphone) via the wireless communication module.

In operation S902, the network interface 1201 receives information about currently available processing capabilities from the computing device 20 and the server device 30 configuring a current network on the image forming system 1. However, there may be no need to receive information about currently available processing capability of the image forming device 10 through the network interface 1201.

In operation S903, the control unit 110 compares the processing capabilities of the image forming device 10, the computing device 20, and the server device 30.

In more detail, the estimation unit 1101 of the control unit 110 estimates times to finish the transmission operations through the data transmission paths that may be established between the devices 10, 20, and 30, based on the processing capabilities of the devices 10, 20, and 30. Otherwise, the estimation unit 1101 of the control unit 110 estimates times to finish the image data generation operations in the devices 10, 20, and 30, based on the processing capabilities of the devices 10, 20, and 30.

That is, the estimation unit 1101 of the control unit 110 may estimate the time taken to perform one of the transfer operation and the generation operation.

In operation S904, the control unit 110 determines at least one device based on a result of comparing the processing capabilities of the image forming device 10, the computing device 20, and the server device 30.

In more detail, the device determination unit 1103 of the control unit 110 determines at least one device corresponding to the shortest estimation time from among the devices 10, 20, and 30.

As described above, the control unit 110 determines the image forming device 10 and the computing device 20 included in the path \textcircled{1} of FIG. 4 and may determine the computing device 20 corresponding to the rendering \textcircled{2} shown in FIG. 6.

In operation S905, since the control unit 110 determines the path \textcircled{1} and the rendering \textcircled{2}, the network interface 1201 transfers command information generated by the control unit 110 to the computing device 20.

In operation S906, the network interface 1201 receives image data that is rendered in the computing device 20.

In operation S907, the image forming unit 130 performs the image job by using the image data rendered in the computing device 20.

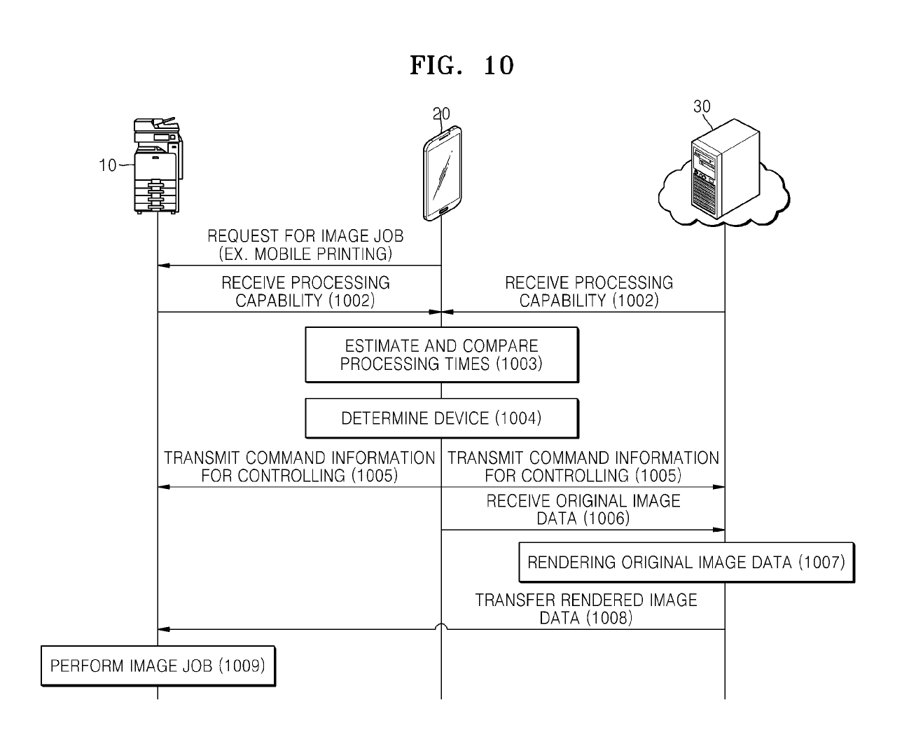

FIG. 10 is a diagram showing processes of controlling data flow in the image forming device 10, the computing device 20, and the server device 30 according to an embodiment. Referring to FIG. 10, the processes of controlling the data flow are time-serially performed processes in the devices 10, 20, and 30 described with reference to FIGS. 1 through 7, and thus, the descriptions with reference to FIGS. 1 through 7 may be applied to the processes of controlling the data flow in FIG. 10.

The controlling of the data flow shown in FIG. 10 is performed by the computing device 20. In addition, the processes of controlling the data flow shown in FIG. 10 will be described under an assumption of the path \textcircled{2}+\textcircled{3} shown in FIG. 4 and the rendering \textcircled{3} shown in FIG. 6. However, an embodiment is not limited thereto.

In operation S1001, the network interface 2201 transmits a request for an image job (for example, a mobile printing operation) to the image forming device 10 via the wireless communication module.

In operation S1002, the network interface 2201 receives information about currently available processing capabilities from the image forming device 10 and the server device 30 configuring a current network on the image forming system 1. However, there may be no need to receive information about currently available processing capability of the computing device 20 through the network interface 2201.

In operation S1003, the control unit 210 compares the processing capabilities of the image forming device 10, the computing device 20, and the server device 30.

In more detail, the estimation unit 2101 of the control unit 210 estimates times to finish the transmission operations through the data transmission paths that may be established between the devices 10, 20, and 30, based on the processing capabilities of the devices 10, 20, and 30. Otherwise, the estimation unit 2101 of the control unit 210 estimates times to finish the image data generation operations in the devices 10, 20, and 30, based on the processing capabilities of the devices 10, 20, and 30.

That is, the estimation unit 2101 of the control unit 210 may estimate the time taken to perform one of the transfer operation and the generation operation.

In operation S1004, the control unit 210 determines at least one device based on a result of comparing the processing capabilities of the image forming device 10, the computing device 20, and the server device 30.

In more detail, the device determination unit 2103 of the control unit 210 determines at least one device corresponding to the shortest estimation time from among the devices 10, 20, and 30.

As described above, the control unit 210 determines the computing device 20 and the server device 30 included in the path \textcircled{2}+\textcircled{3} of FIG. 4 and may determine the server device 30 corresponding to the rendering \textcircled{3} shown in FIG. 6.

In operation S1005, since the control unit 210 determines the path \textcircled{2}+\textcircled{3} and the rendering \textcircled{3}, the network interface 2201 transfers command information generated by the control unit 210 to the image forming device 10 and the server device 30.

In operation S1006, the network interface 2201 transfers original image data stored in the computing device 20 to the server device 30.

In operation S1007, the server device 30 performs the rendering operation for converting the original image data into the image data of printable format (cloud rendering).

In operation S1008, the server device 30 transfers the rendered image data to the image forming device 10 according to the command information.

In operation S1009, the image forming device 130 performs the image job by using the image data rendered in the server device 30.

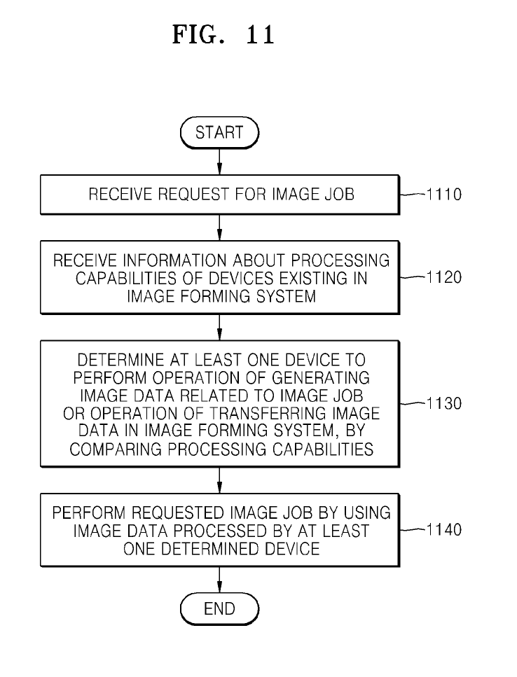

FIG. 11 is a diagram illustrating processes of controlling data flow in the image forming device 10 of the image forming system 1 according to an embodiment. Referring to FIG. 11, the processes of controlling the data flow are time-serially performed processes in the devices 10, 20, and 30 described with reference to FIGS. 1 through 7, and thus, the descriptions with reference to FIGS. 1 through 7 may be applied to the processes of controlling the data flow in FIG. 11.

In operation S1110, the network interface 1201 or the user interface 1203 of the interface 120 receives a request for an image job.

In operation S1120, the network interface 1201 receives information about processing capabilities (processing capabilities information) of the devices 10, 20, and 30 included in the image forming system 1.

In operation S1130, the control unit 110 compares the processing capabilities of the devices 10, 20, and 30 so as to determine at least one device that will process an operation of generating or transferring image data in the image forming system 1.

In operation S1140, the image forming unit 130 performs the requested image job by using the image data processed by the determined at least one device.

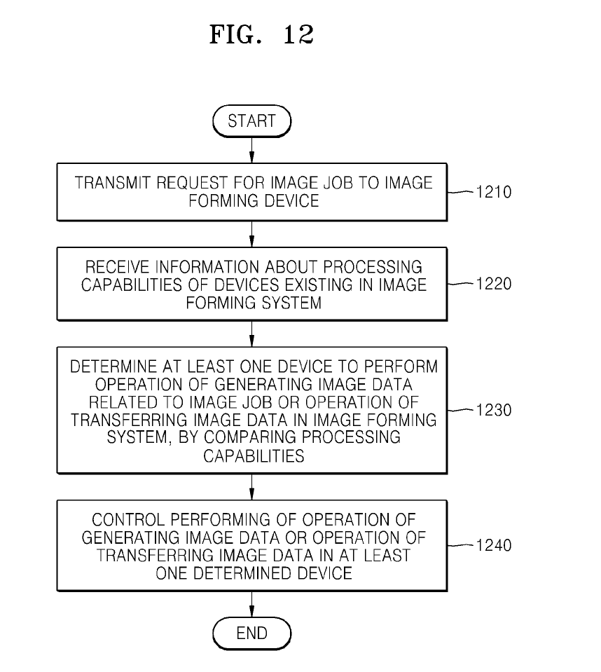

FIG. 12 is a diagram illustrating processes of controlling data flow in the computing device 20 of the image forming system 1. Referring to FIG. 12, the processes of controlling the data flow are time-serially performed processes in the devices 10, 20, and 30 described with reference to FIGS. 1 through 8, and thus, the descriptions with reference to FIGS. 1 through 8 may be applied to the processes of controlling the data flow in FIG. 12.

In operation S1210, the network interface 2201 transmits a request for an image job to the image forming device 10 included in the image forming system 1.

In operation S1220, the network interface 2201 receives information about processing capabilities of the devices 10, 20, and 30 included in the image forming system 1.

In operation S1230, the control unit 210 compares the processing capabilities of the devices 10, 20, and 30 so as to determine at least one device that will process an operation of generating or transferring image data in the image forming system 1.

In operation S1240, the control unit 210 controls the performing of the generation operation of the transfer operation in the determined at least one device.

As described above, according to the one or more embodiments, the data flow on the image forming system may be dynamically controlled by the image forming device or the computing device according to a current status, and thus, the image job may be effectively and rapidly performed when compared with the case using the fixed path and limited resources.

In addition, other embodiments can also be implemented through computer readable code/instructions in/on a medium, e.g., a computer readable medium, to control at least one processing element to implement any above described embodiment. The medium can correspond to any medium/media permitting the storage and/or transmission of the computer readable code.

The computer readable code can be recorded/transferred on a medium in a variety of ways, with examples of the medium including recording media, such as magnetic storage media (e.g., ROM, floppy disks, hard disks, etc.) and optical recording media (e.g., CD-ROMs, or DVDs).

Processes, functions, methods, and/or software in apparatuses described herein may be recorded, stored, or fixed in one or more non-transitory computer-readable storage media (computer readable recording medium) that includes program instructions (computer readable instructions) to be implemented by a computer to cause one or more processors to execute or perform the program instructions. The media may also include, alone or in combination with the program instructions, data files, data structures, and the like. The media and program instructions may be those specially designed and constructed, or they may be of the kind well-known and available to those having skill in the computer software arts. Examples of non-transitory computer-readable storage media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The program instructions may be executed by one or more processors. The described hardware devices may be configured to act as one or more software modules that are recorded, stored, or fixed in one or more computer-readable storage media, in order to perform the operations and methods described above, or vice versa. In addition, a non-transitory computer-readable storage medium may be distributed among computer systems connected through a network and computer-readable codes or program instructions may be stored and executed in a decentralized manner. In addition, the computer-readable storage media may also be embodied in at least one application specific integrated circuit (ASIC) or Field Programmable Gate Array (FPGA).

It should be understood that the exemplary embodiments described therein should be considered in a descriptive sense only and not for purposes of limitation. Descriptions of features or aspects within each embodiment should typically be considered as available for other similar features or aspects in other embodiments.

While one or more embodiments have been described with reference to the figures, it will be understood by those of ordinary skill in the art that various changes in form and details may be made therein without departing from the spirit and scope of the present disclosure as defined by the following claims and their equivalents.

What is claimed is:

1. An image forming device controlling a data flow for an image forming system, the image forming device comprising:
an interface to receive a request for an image job;
a control unit to compare processing capability information of devices in the image forming system to determine at least one device that would perform an operation of generating image data related to the requested image job or an operation of transferring the image data; and
an image forming unit to perform the requested image job by using the image data processed by the determined at least one device.

2. The image forming device of claim 1, wherein the processing capability information comprises information of the processing capabilities measured based on at least one of processing performances of processors included in the devices for performing the operation of generating the image data and communication performances of network interfaces included in the devices for performing the operation of transferring the image data between the devices.

3. The image forming device of claim 1, wherein the control unit comprises:
an estimation unit for estimating a time taken for finishing the operation of generating the image data in each of the devices based on the processing capabilities of the devices; and
a device determination unit for determining a device having a shortest estimation time from among the devices.

4. The image forming device of claim 3, wherein the operation for generating the image data is a rendering operation for converting original image data into the image data of a printable format.

5. The image forming device of claim 1, wherein the control unit comprises:
an estimation unit to estimate a time taken for finishing the operation of transferring the image data through each of data transmission paths that may be established between the devices, based on the processing capabilities of the devices; and
a device determination unit to determine devices included in a data transmission path having a shortest estimation time from among the data transmission paths.

6. The image forming device of claim 5, wherein the data transmission paths are established by using at least one of Wi-Fi, Wi-Fi Direct, near field communication (NFC), Bluetooth, Zigbee, infrared data association (IrDA), and a wired connection.

7. The image forming device of claim 1, wherein the interface comprises:
a user interface to receive information from a user and providing the user with information; and
a network interface to transmit/receive data by using at least one of wired connection and wireless connection,
wherein the request for the image job comprises at least one of a request input from the user via the user interface and a request transmitted from other devices out of the image forming device via the network interface.

8. The image forming device of claim 7, wherein the control unit generates command information for controlling performing of the operation of generating the image data or the operation of transferring the image data in the determined at least one device, and if at least one device other than the image forming device is included in the determined at least one device, the network interface transmits the command information to the at least one device other than the image forming device.

9. The image forming device of claim 7, wherein if at least one device other than the image forming device is included in the determined at least one device, the network interface receives image data processed in the at least one device other than the image forming device, and the image forming unit performs the requested image job by using the image data.

10. The image forming device of claim 7, wherein the network interface receives information of the processing capabilities of the devices in the image forming system, and the control unit determines the at least one device by using the information of the processing capabilities.

11. The image forming device of claim 1, wherein the devices in the image forming system comprise the image forming device, at least one computing device, and at least one server device providing a cloud service.

12. A computing device for controlling data flow on an image forming system, the computing device comprising:
a network interface to transmit a request for an image job to an image forming device in the image forming system; and
a control unit to compare processing capability information of devices existing in the image forming system so as to determine at least one device that would process an operation of generating image data related to the requested image job or an operation of transferring the image data in the image forming system,
wherein the control unit controls performing of the operation of generating the image data or the operation of transferring the image data in the determined at least one device.

13. The computing device of claim 12, wherein the processing capability information comprises information of the processing capabilities measured based on at least one of processing performances of processors included in the devices for performing the operation of generating the image data and communication performances of network interfaces included in the devices for performing the operation of transferring the image data between the devices.

14. A method of controlling data flow in an image forming device of an image forming system, the method comprising:
receiving a request for an image job;
receiving information of processing capabilities of devices in the image forming system;
comparing processing capabilities of devices in the image forming system so as to determine at least one device that would process an operation of generating image data related to the requested image job or an operation of transferring the image data in the image forming system; and
performing the requested image job by using image data processed by the determined at least one device.

15. The method of claim 14, wherein the processing capability information comprises information of at least one of processing performances of processors included in the devices for performing the operation of generating the image data and communication performances of network interfaces included in the devices for performing the operation of transferring the image data between the devices.

16. The method of claim 14, wherein the determining of the at least one device comprises:
estimating at least one of a time taken for finishing the operation of generating the image data in each of the devices and a time taken for finishing the operation of transferring the image data through each of data transmission paths that may be established between the devices, based on the processing capabilities of the devices; and
determining at least one of a device having a shortest estimation time and devices included in a data transmission path having a shortest estimation time from among the data transmission paths.

17. The method of claim 14, further comprising:
generating command information for controlling performing of the operation of generating the image data or the operation of transferring the image data in the at least one determined device; and
if at least one device other than the image forming device is included in the at least one determined device, transferring the command information to the at least one device other than the image forming device.

18. The method of claim 17, further comprising, if at least one device other than the image forming device is included in the at least one determined device, receiving image data processed in the at least one device other than the image forming device,
wherein the performing of the image job comprises performing the requested image job by using the image data.

19. A method of controlling data flow in a computing device of an image forming system, the method comprising:
transmitting a request for an image job to an image forming device existing in the image forming system;
receiving information of processing capabilities of devices in the image forming system;
comparing processing capabilities of devices in the image forming system so as to determine at least one device that would process an operation of generating image data related to the requested image job or an operation of transferring the image data in the image forming system; and
controlling performance of the requested image job in the at least one determined device.

20. At least one computer readable medium storing computer readable instructions that control at least one processor to implement the method of claim 14.
